(19) United States
(12) Patent Application Publication
(10) Pub. No.: US 2020/0389338 A1
(43) Pub. Date: Dec. 10, 2020

(54) APPARATUS FOR CONTROLLING VEHICLE NETWORK MANAGEMENT, SYSTEM INCLUDING SAME AND METHOD THEREOF

(71) Applicants: HYUNDAI MOTOR COMPANY, Seoul (KR); KIA MOTORS CORPORATION, Seoul (KR)

(72) Inventor: Pil Yong PARK, Seoul (KR)

(21) Appl. No.: 16/666,915

(22) Filed: Oct. 29, 2019

(30) Foreign Application Priority Data
Jun. 10, 2019 (KR) 10-2019-0067890

(51) Int. Cl. H04L 12/40; H04L 12/24; G06F 1/14; G06F 9/4401

(52) U.S. Cl. CPC H04L 12/40; H04L 41/046; H04L 2012/40273; G06F 9/4418; G06F 1/14

(57) ABSTRACT

A vehicle system includes: a first vehicle network management control apparatus that manages a first network; and a second vehicle network management control apparatus that communicates with the first vehicle network management control apparatus and manages a second network. The first and second vehicle network management control apparatuses enter a sleep mode while synchronizing with each other.

### CROSS-REFERENCE TO RELATED APPLICATION

This application claims the benefit of priority to Korean Patent Application No. 10-2019-0067890, filed in the Korean Intellectual Property Office on Jun. 10, 2019, the entire contents of which are incorporated herein by reference.

### TECHNICAL FIELD

The present disclosure relates to an apparatus for controlling vehicle network management, a system including the same, and a method thereof, and more particularly, to a technique of controlling network management for a hybrid network of a vehicle.

### BACKGROUND

An electronic control unit (ECU), which is a small computer mounted on a vehicle, receives and computes signals sensed by sensors mounted on a vehicle engine, a transmission, a power steering, an air conditioner, and the like, and performs functions of generating and transmitting signals for driving actuators of an idle adjustment device, a fuel injection device, a variable intake control device, and the like.

A plurality of ECUs installed in the vehicle perform network management of the vehicle by transmitting and receiving network management messages to each other.

In the network management, when network communication is not required for efficient management of vehicle power, a plurality of ECUs connected to the network are simultaneously changed into a low power mode (sleep mode), and when network communication is again required, the mode changes from the low power mode to the normal mode.

Due to the development of vehicle technology, such network management becomes an important issue as the in-vehicle network becomes complicated.

### SUMMARY

The present disclosure has been made to solve the above-mentioned problems occurring in the prior art while advantages achieved by the prior art are maintained intact.

An aspect of the present disclosure provides an apparatus for controlling vehicle network management that is capable of performing sleep mode entry (shutdown) synchronization between network management control apparatuses in a hybrid network of a vehicle, a system including the same, and a method thereof.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a vehicle system includes: a first vehicle network management control apparatus that manages a first network; and a second vehicle network management control apparatus that communicates with the first vehicle network management control apparatus and manages a second network, wherein the first and second vehicle network management control apparatuses enter a sleep mode while synchronizing with each other.

The vehicle system may further include a third vehicle network management control apparatus that communicates with the second vehicle network management control apparatus and manage a third network.

The vehicle system may include the first vehicle network management control apparatus located at a highest level, the second vehicle network management control apparatus located at a lower level of the first vehicle network management control apparatus, and the third vehicle network management control apparatus located at a lower level of the second vehicle network management control apparatus.

The first vehicle network management control apparatus may determine whether a bus or node in the first network is in a sleep ready state.

The first vehicle network management control apparatus may determine that the bus or node in the first network is in the sleep ready state when a network management message is not received for a preset period time from the bus or node in the first network.

The first vehicle network management control apparatus may notify the second vehicle network management control apparatus of the entry into the sleep mode when the bus or node in the first network is in the sleep ready state.

The second vehicle network management control apparatus may allow a sleep delay timer to start counting when receiving a sleep mode entry notification from the first vehicle network management control apparatus, and transmit the sleep mode entry notification to the third vehicle network management control apparatus.

The third vehicle network management control apparatus may allow a sleep delay timer to start counting when receiving the sleep mode entry notification from the second vehicle network management control apparatus, and may allow a bus or node of the third network to enter the sleep mode when the counting of the sleep delay timer is completed.

The second vehicle network management control apparatus may allow a bus or node of the second network to enter the sleep mode when the counting of the sleep delay timer is completed.

A counting value of the sleep delay timer of the second vehicle network management control apparatus may be set to be smaller than a counting value of the sleep delay timer of the third vehicle network management control apparatus, wherein the sleep delay timers of the second and third vehicle network management control apparatuses may be set to end simultaneously.

The second and third vehicle network management control apparatuses may notify the first vehicle network management control apparatus of completion of the sleep mode entry upon completion of the sleep mode entry.

The entry into the sleep mode may be stopped when at least one of the first to third vehicle network management control apparatuses receives a wake-up request or an error occurs in entering the sleep mode.

According to another aspect of the present disclosure, an apparatus for controlling vehicle network management includes: a processor that allows a sleep delay timer to start counting when a sleep mode entry is notified from an upper-level network management control apparatus managing a network in a vehicle, and allows a bus or node in a network of the processor to enter a sleep mode when the counting of the sleep delay timer ends; and a storage that stores a counting value of the sleep delay timer.

The processor may transmit a sleep mode entry notification to a lower-level vehicle network management control apparatus when the sleep delay timer starts counting.

The processor may notify the upper-level network management control apparatus of completion of the sleep mode entry when the bus or node in the network enters the sleep mode.

The processor may allow the bus or node in the network to stop entering the sleep mode when the processor receives a wake-up request from an individual bus or an error occurs in entering the sleep mode.

According to still another aspect of the present disclosure, a method of controlling management of a vehicle network which include at least one vehicle network management control apparatus includes: receiving a sleep mode entry notification from an upper-level vehicle network management control apparatus; starting counting of a sleep delay timer;

and performing a sleep mode entry of a network when the counting of the sleep delay timer ends.

The method may further include notifying the upper-level vehicle network management control apparatus of sleep mode entry completion when the sleep mode entry is completed.

The method may further include stopping the sleep mode entry when a wake up request is received from a bus or node or an error occurs in entering the sleep mode.

The method may further include notifying the sleep mode entry when the upper-level vehicle network management control apparatus does not receive a network management message from a bus or node for a preset period time.

### BRIEF DESCRIPTION OF THE DRAWINGS

The above and other objects, features and advantages of the present disclosure will be more apparent from the following detailed description taken in conjunction with the accompanying drawings:

FIG. 1 is an exemplary view illustrating a single network of a vehicle according to an exemplary embodiment of the present disclosure;

FIG. 2 is an exemplary view illustrating a hybrid network of a vehicle according to an exemplary embodiment of the present disclosure;

FIG. 3 is an exemplary view illustrating a hierarchical structure of a hybrid network of a vehicle according to an exemplary embodiment of the present disclosure;

FIG. 4 is a block diagram illustrating an internal configuration of a vehicle network management control apparatus according to an exemplary embodiment of the present disclosure;

FIG. 5A is an exemplary view illustrating a hybrid network in which a gateway serves as a network management control apparatus according to an exemplary embodiment of the present disclosure;

FIG. 5B is a table illustrating an example of active control and manual control in the hybrid network shown in FIG. 5A;

FIG. 6 is a diagram for explaining a state change of each node of a vehicle network according to an exemplary embodiment of the present disclosure;

FIG. 7 is a view illustrating a structure of a network management message of a vehicle according to an exemplary embodiment of the present disclosure;

FIG. 8 is a flowchart illustrating a vehicle network management control method according to an exemplary embodiment of the present disclosure; and

FIG. 9 is a view illustrating a computing system according to an exemplary embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The present disclosure discloses a technique of performing a vehicle sleep mode entry (shutdown) while synchronizing between network management control apparatuses in a hybrid network including a plurality of networks managed by a plurality of network management control apparatuses.

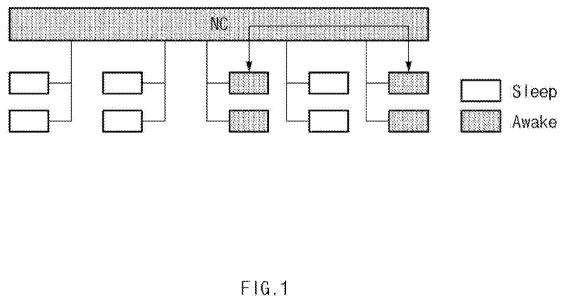

Hereinafter, exemplary embodiments of the present disclosure will be described in detail with reference to FIGS. 1 to 9.

FIG. 1 is an exemplary view illustrating a single network of a vehicle according to an exemplary embodiment of the present disclosure.

A network management (NM) function means managing a node, a single bus, and a network between several buses. Referring to FIG. 1, one network management coordinator (NC) is connected to several networks including each node (e.g., an ECU) connected to a network management coordinator. In this case, each network may include sleeping nodes and awake nodes.

The network management (NM) may utilize the network management function performed on a single bus to perform a sleep control for a part of a bus or an entire bus. The controller that performs such a network management (NM) control is referred to as an NM coordinator (NC). The NC may operate for an NM cluster (NMC) connected through several buses and perform a sleep synchronization function in connection with network management on an individual bus. That is, the NC corresponds to a vehicle network management control apparatus of the present disclosure. The NMC means a bundle of plural networks managed by the NC.

As shown in FIG. 1, because several networks are controlled by a single NC, it is easy to manage functions of a sleep mode (shutdown), and the like in the entire network.

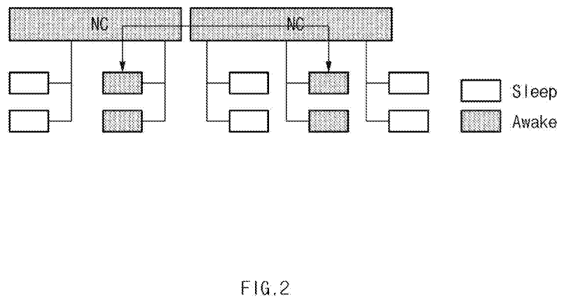

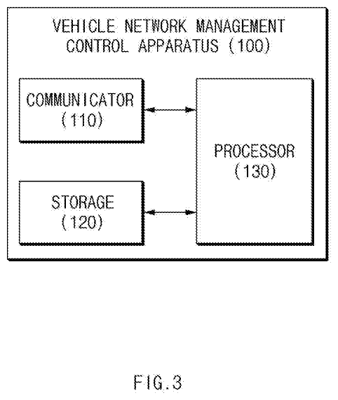

FIG. 2 is an exemplary view illustrating a hybrid network of a vehicle according to an exemplary embodiment of the present disclosure. FIG. 3 is an exemplary view illustrating a hierarchical structure of a hybrid network of a vehicle according to an exemplary embodiment of the present disclosure.

FIG. 2 illustrates an example in which an Ethernet backbone and distribution control are expanded and a plurality of NCs are provided, thereby constituting a hybrid network between NCs. That is, because there are provided a plurality of NCs which are the subjects of managing the shutdown of a vehicle, control for shutdown synchronization between networks between the NCs is required.

FIG. 3 illustrates a network configuration in which a domain control unit (DCU), which is an NC, controls lower-level CAN controllers (e.g., ECUs) and DCUs are Ethernet-networked. DCU ‘A’, ‘B’ and ‘C’ actively control the lower-level CAN network, and the DCU is actively controlled by a central computing unit (CCU) which is the highest-level NC.

That is, when the CCU, which is the highest NC, notifies the start of the sleep mode entry to DCU ‘A’, DCU ‘B’, and DCU ‘C’, which are lower-level NCs, each of DCU ‘A’, DCU ‘B’, and DCU ‘C’ operates a sleep delay timer to count. When the counting is ended, each of DCU ‘A’, DCU ‘B’, and DCU ‘C’ enters a sleep mode and the sleep mode is notified to the CCU, which is the highest-level NC, such that the sleep mode synchronization between the NCs is possible.

A vehicle system according to an exemplary embodiment of the present disclosure may include a first vehicle network management control apparatus (e.g., CCU) that manages a first network, a second vehicle network management control apparatus (e.g., DCU ‘A’) that communicates with the first vehicle network management control apparatus and manages a second network, and a third vehicle network management control apparatus (DCU ‘B’) that communicates with the second vehicle network management control apparatus and manages a third network.

In this case, the first vehicle network management control apparatus (CCU), the second vehicle network management control apparatus (DCU ‘A’), and the third vehicle network management control apparatus (DCU ‘B’) may perform the sleep mode entry while synchronizing with each other.

There is provided a hierarchical structure in which the first vehicle network management control apparatus is located at the highest level, the second vehicle network management control apparatus is located at the lower level of the first vehicle network management control apparatus, and the third vehicle network management control apparatus is located at the lower level of the second vehicle network management control apparatus.

The first vehicle network management control apparatus may determine that the bus or node in the first network is in the sleep ready state when the network management message is not received from the bus or the node in the first network for a predetermined period of time, and may notify the second vehicle network management control apparatus of the entry into the sleep mode when it is determined that the bus or node in the first network is in the sleep ready state.

Then, when the second vehicle network management control apparatus is notified of the entry into the sleep mode from the first vehicle network management control apparatus, the second vehicle network management control apparatus allows the sleep delay timer to start counting and transmits a sleep mode entry notification to the third vehicle network management control apparatus. Then, when the third vehicle network management control apparatus is notified of the entry into the sleep mode from the second vehicle network management control apparatus, the third vehicle network management control apparatus allows the sleep delay timer to start counting, and when the counting of the sleep delay timer is completed, the third vehicle network management control apparatus allows the bus and node of the third network to enter the sleep mode. In addition, when the counting of the sleep delay timer is completed, the second vehicle network management control apparatus allows the bus and node of the second network to enter the sleep mode.

In this case, the count value of the sleep delay timer of the second vehicle network management control apparatus is set to be smaller than the count value of the sleep delay timer of the third vehicle network management control apparatus, and the sleep delay timers of the second and third vehicle network management control apparatuses are set to be concurrently ended.

In addition, when the sleep mode entries of the second and third vehicle network management control apparatuses are completed, the second and third vehicle network management control apparatuses may notify the first vehicle network management control apparatus of completion of the sleep mode entry.

In addition, when at least one of the first to third vehicle network management control apparatuses receives a wake-up request or an error occurs in entering the sleep mode, the entry into the sleep mode may be stopped.

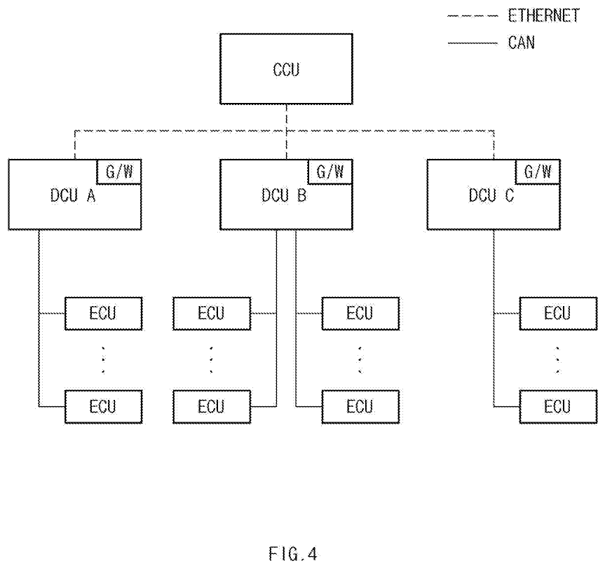

FIG. 4 is a block diagram illustrating an internal configuration of a vehicle network management control apparatus according to an exemplary embodiment of the present disclosure.

When a vehicle network management control apparatus 100 is notified of the entry into the sleep mode from an upper-level network management control apparatus managing a network in the vehicle, the vehicle network management control apparatus 100 allows the sleep delay timer to start counting. When the counting of the sleep delay timer is ended, the vehicle network management control apparatus 100 may allow the bus and node in the network thereof to enter the sleep mode.

The vehicle network management control apparatus 100 may include a communicator 110, storage 120, and a processor 130.

The communicator 110 is a hardware device for performing in-vehicle communication through CAN communication, LIN communication, Ethernet communication, and the like.

The storage 120 may store information received and transmitted between the NC and the controllers in the vehicle, and the like. The storage 120 may include at least one type of a storage medium of memories of a flash memory type, a hard disk type, a micro type, a card type (e.g., a secure digital (SD) card or an extreme digital (XD) card), and the like, and a random access memory (RAM), a static RAM (SRAM), a read-only memory (ROM), a programmable ROM (PROM), an electrically erasable PROM (EEPROM), a magnetic memory (MRAM), a magnetic disk, and an optical disk type memory.

The processor 130 may be electrically connected to the communicator 110 and the storage 120, may electrically control each configuration, and may be an electrical circuit executing commands of software, so that various data processing and calculations described below may be performed.

When the processor 130 is notified of the entry into the sleep mode from the upper-level network management control apparatus that manages a network in the vehicle, the processor 130 may allow the sleep delay timer to start counting. When the counting of the sleep delay timer is completed, the processor 130 may allow the bus and node in the network thereof to enter the sleep mode.

The processor 130 may transmit the sleep mode entry notification to the lower-level vehicle network management control apparatus when the sleep delay timer starts counting. When the network enters the sleep mode, the processor 130 may notify the upper-level network management control apparatus of the completion of the sleep mode entry.

The processor 130 may stop entering the sleep mode when a wake-up request is received from an individual bus or an error occurs in entering the sleep mode.

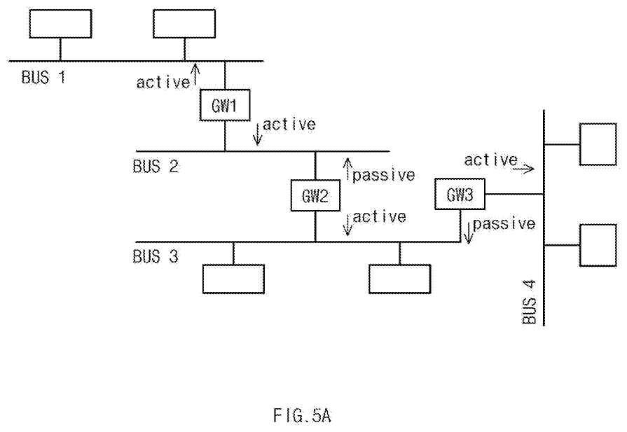

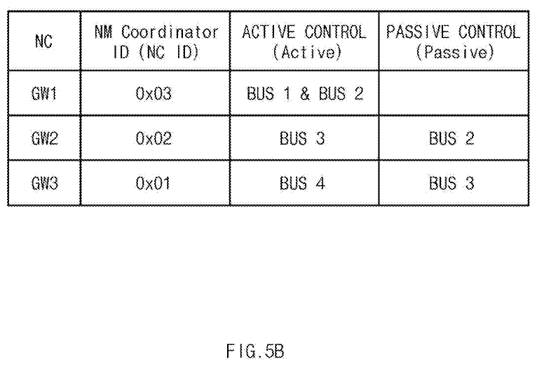

FIG. 5A is an exemplary view illustrating a hybrid network in which a gateway serves as a network management control apparatus according to an exemplary embodiment of the present disclosure. FIG. 5B is a table illustrating an example of active control and manual control in the hybrid network shown in FIG. 5A.

Hereinafter, a method of performing a coordinated shutdown in a hybrid network of a vehicle will be described with reference to FIG. 5A.

In FIG. 5A, a gateway GW1 serves as the highest-level NC (a vehicle network management control apparatus), and gateways GW2 and GW3 serve as lower-level NCs. The gateway GW1 is connected to buses 1 and 2, the gateway GW2 is connected to buses 2 and 3, and the gateway GW3 is connected to buses 3 and 4.

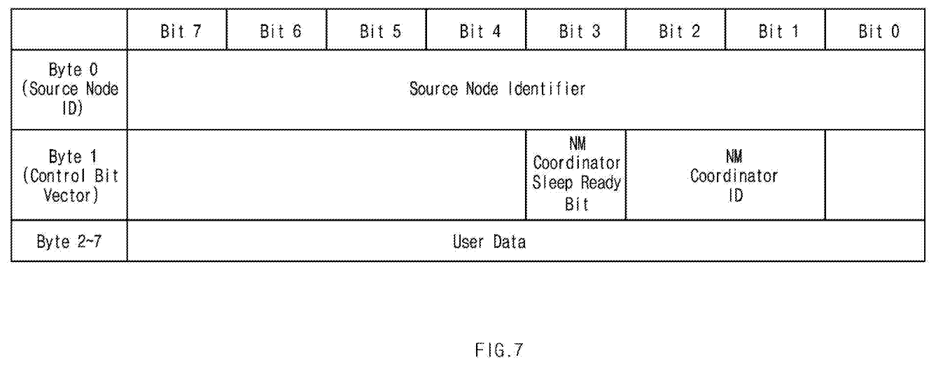

In this case, when the gateway GW1 which is the highest-level NC informs the start of the sleep mode, the start of the sleep mode is notified to the buses 1 and 2 through an active channel. Then, the gateway GW2 that receives a sleep mode start message through the bus 2 forwards the sleep mode start message to the bus 3 through the active channel. The gateway GW3 that receives the sleep mode start message through the bus 3 forwards the sleep mode start message to each node connected to the bus 4 through the active channel. In this case, the sleep mode start message may include a case where the value of the NC sleep ready bit (NM coordinator sleep ready bit) is 1 in the network management message structure of FIG. 7.

That is, in order to adjust the sleep between the overlapped lower-level buses, several NCs (NC coordinators) are set in a hierarchical structure for performing adjustment for the lower-level bus structure. The highest-level NC (gateway GW1) performs an active function for all the channels constituting each NMC (NM cluster, a bundle of several networks managed by the NC) and starts the entire sleep process.

After receiving the sleep start message from the highest-level NC (gateway GW1) through a passive channel, the lower-level NC (gateway GW2) transmits the information to other NCs (gateway GW3) connected through the active channel. In this case, the NC may transmit an NM message to a channel that serves as a passive channel only when the NC node has an NM request hold message or the corresponding NC is not ready for sleep mode on the channel serving as an active channel. In addition, ‘0x00’ is used as an NM coordination ID value used for the NM message transmitted through the passive channel.

When all the nodes in the NMC are ready to sleep, the highest-level NC transmits ‘Coordinator Sleep Ready Bit=1’ through the active channel. When the lower-level NC receives a sleep notification through the passive channel, the lower-level NC must transmit ‘NM Coordinator Sleep Ready=1’ to the active channel. The lower-level NC transmits ‘NM Coordinator sleep Ready=0’ to all active channels when sleep cancellation occurs on the passive channel. In addition, the lower-level NC does not set the sleep ready bit in the passive channel, and forwards, to the active channel, a change in the NM coordinator sleep ready bit state received through the passive channel. The NC must request ‘Sleep Ready Bit=1’ and then initiate an adjusted shutdown.

The NC may set ‘NM Coordinator Sleep Ready=0’ on all active channels when the adjusted shutdown is interrupted. In this case, shut down of the buses may be performed independently for each NMC. When an NC and another controller request a bus, the NC makes a network request to the NM of each bus and remains in an active state for all the buses in the NMC. When all the buses in the NMC are ready to sleep or are already in the sleep mode, the NC may start shutting down on the awake bus. In this case, the NC may always monitor the shutdown start condition and timing.

After the start of the shutdown, each NC allows the timer to count for the set sleep delay timer time, and after the counting of the sleep delay timer of each NC ends, each NC performs a sleep mode entry (shut down) for each network.

When each NC (gateways GW1, GW2 and GW3) receives a wakeup request from an individual bus (bus 1, bus 2, bus 3 and bus 4), each NC forwards the wakeup requests to NM of each bus.

When the NC receives a network request from a specific node in the NMC before all the networks enter the bus sleep mode after the start of the sleep mode entry for the NMC, the NC stops the entry into the sleep mode and performs a network request for all networks including a network that already enters the bus sleep mode.

In this case, the corresponding NC transmits an NM message in which the ready sleep bit is set to ‘0’ in order to stop the entry into the sleep mode, and the NC which has received the NM message stops the entry into the sleep mode. In addition, when an error occurs in the network release after the start of the sleep mode entry, the NC stops the entry into the sleep mode and performs a network request including the network in which the error has occurred.

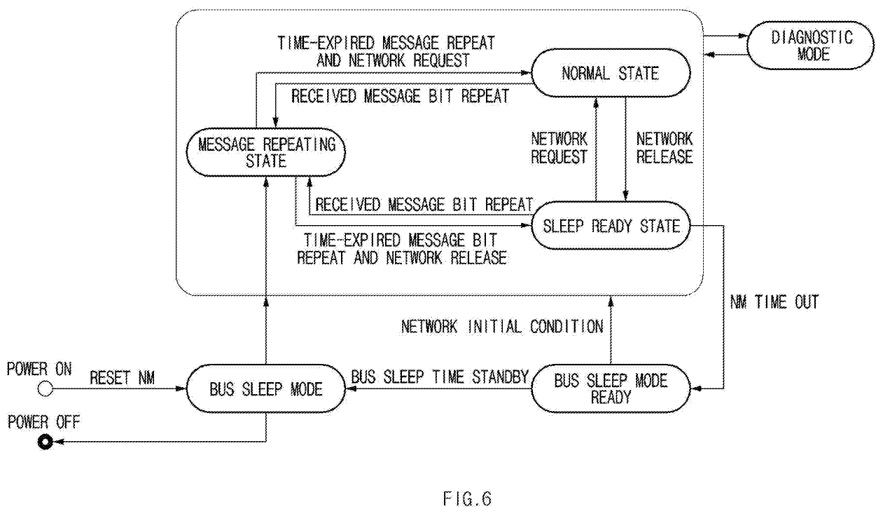

FIG. 6 is a diagram for explaining a state change of each node of a vehicle network according to an exemplary embodiment of the present disclosure.

The network management may perform start, end, and error processing functions of a network for each node in order to manage the linkage function between the nodes.

Referring to FIG. 6, all network nodes to which the NM is applied may perform network activity using the state defined as shown in FIG. 6. All network nodes may perform a network management function using periodically transmitted NM messages, and the NM message transmitted from each node may be received at all nodes in the cluster.

The NM message reception means that the transmission node desires to maintain the state of the current wakeup NM cluster. When a node is ready to enter the bus sleep mode, the node stops transmitting the NM message and waits for a transition to the bus sleep mode while maintaining reception of the NM message transmitted by other nodes.

Accordingly, when there is no more NM message reception, after the timer time allocated for the sleep mode standby elapses, all the nodes start the transition to the bus sleep mode. When a node in the NM cluster in the bus sleep mode requests communication, the NM cluster is awakened by transmitting an NM message.

FIG. 7 is a view illustrating a structure of a network management message of a vehicle according to an exemplary embodiment of the present disclosure. Referring to FIG. 7, the network management message has a message length of 8 bytes, the 0-th byte includes a source node identifier, and the first byte includes an NC sleep ready bit (NM coordinator sleep ready bit) and an NM coordinator ID as a control bit vector (CBV). The remaining bytes of the second byte to the seventh byte may include user data.

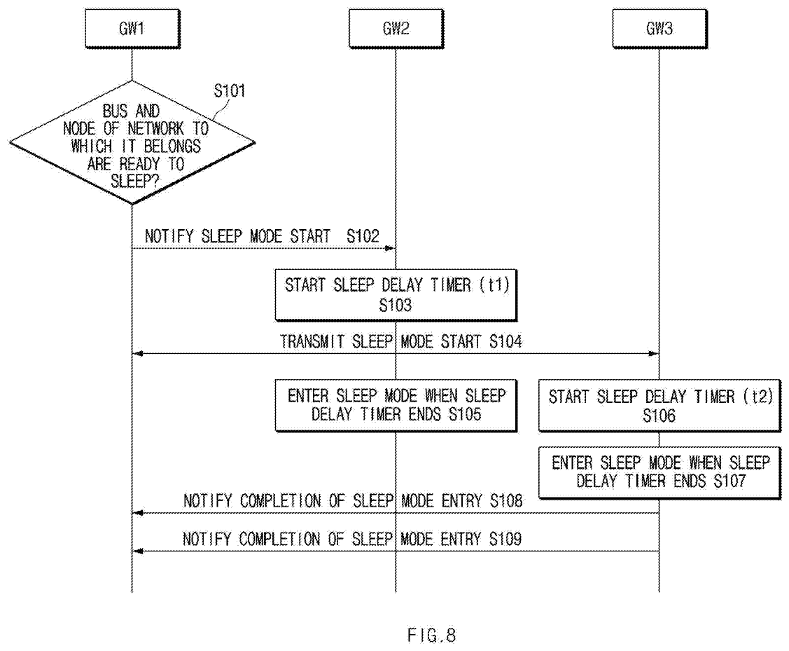

Hereinafter, a vehicle network management control method according to an exemplary embodiment of the present disclosure will be described in detail with reference to FIG. 8. FIG. 8 is a flowchart illustrating a vehicle network management control method according to an exemplary embodiment of the present disclosure.

Hereinafter, it is assumed that the vehicle network management control apparatus 100 of FIG. 3 performs the process of FIG. 8. The gateways GW1, GW2, GW3 of FIG. 5A are driven as the vehicle network management control apparatus 100. In addition, in FIG. 8, it may be understood that the operation described as being performed by the apparatus is controlled by the processor 130 of the vehicle network management control apparatus 100. In addition, as an example, a case where the gateway GW1 is driven as the highest-level network management control apparatus, the gateway GW2 is a lower-level network management control apparatus connected to the gateway GW1, and the gateway GW3 is driven as a lower-level network management control apparatus connected to the gateway GW2 will be described.

Referring to FIG. 8, in operation S101, the gateway GW1, which is the highest-level network management control apparatus, determines whether the bus and the node of the network to which the gateway GW1 belongs are in a sleep ready state. The gateway GW1 may determine that the bus and the node of the network to which the gateway GW1 belongs are in the sleep ready state when any network management messages are not received from the nodes (e.g., ECU, and the like) of the network to which the gateway GW1 belongs.

Then, the gateway GW1 notifies the gateway GW2 which is the lower-level vehicle network management control apparatus of the start of the sleep mode in operation S102, and the gateway GW2 allows the sleep delay timer to start in operation S103.

Next, the gateway GW1 notifies the gateway GW3 which is the lower-level vehicle network management control apparatus of the start of the sleep mode in operation S104, and the gateway GW2 allows the sleep delay timer to start in operation S105. In this case, the start of the sleep mode means that all the nodes constituting the bus start to enter the sleep mode.

In this case, although a sequence of notifying the gateway GW3 of the start of the sleep mode after the start of the sleep delay timer of the gateway GW2 in operation S103 is disclosed in FIG. 8, the operations S103 and S104 are performed in parallel at almost the same time.

Thereafter, in operations S106 and S107, each of the gateways GW2 and GW3 enters the sleep mode when the sleep delay timer is ended.

Next, in operations S108 and S109, each of the gateways GW2 and GW3 notifies the gateway GW1 which is the highest-level vehicle network management control apparatus of the entry into the sleep mode.

As described above, according to an exemplary embodiment of the present disclosure, because an architecture is developed in which the number of high-performance controllers of a vehicle is increased and CAN communication controllers (nodes) are connected to the lower part thereof so that the network is gradually layered, it is possible to synchronize and manage the network shutdown that is managed by each network management control apparatus.

That is, according to an exemplary embodiment of the present disclosure, it is possible to effectively prevent the vehicle discharge problem that may occur due to the non-synchronization of the vehicle shutdown, by performing the synchronous shutdown through the active and manual control between the network management control apparatuses by layering the increasingly complexed vehicle network structure.

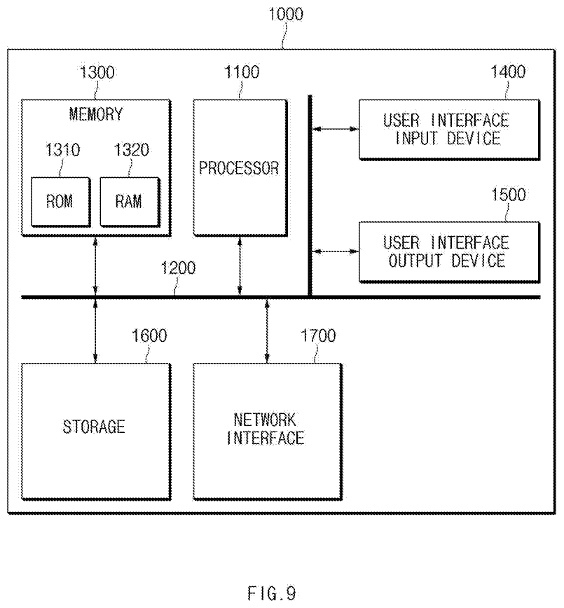

FIG. 9 is a view illustrating a computing system according to an exemplary embodiment of the present disclosure.

Referring to FIG. 9, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

According to the present technology, it is possible to perform sleep mode entry (shutdown) synchronization between network management control apparatuses in a hybrid network of a vehicle, so that the sleep mode entries of the vehicle are performed at the same time, thereby preventing vehicle discharge, and the like.

In addition, various effects that are directly or indirectly understood through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A vehicle system comprising:
a first vehicle network management control apparatus configured to manage a first network; and
a second vehicle network management control apparatus configured to communicate with the first vehicle network management control apparatus and manage a second network,
wherein the first and second vehicle network management control apparatuses enter a sleep mode while synchronizing with each other.

2. The vehicle system of claim 1, further comprising:
a third vehicle network management control apparatus configured to communicate with the second vehicle network management control apparatus and manage a third network.

3. The vehicle system of claim 2, wherein the vehicle system includes the first vehicle network management control apparatus located at a highest level, the second vehicle network management control apparatus located at a lower level of the first vehicle network management control apparatus, and the third vehicle network management control apparatus located at a lower level of the second vehicle network management control apparatus.

4. The vehicle system of claim 2, wherein the first vehicle network management control apparatus is configured to determine whether a bus or node in the first network is in a sleep ready state.

5. The vehicle system of claim 4, wherein the first vehicle network management control apparatus is configured to determine that the bus or node in the first network is in the sleep ready state when a network management message is not received for a preset period of time from the bus or node in the first network.

6. The vehicle system of claim 4, wherein the first vehicle network management control apparatus is configured to notify the second vehicle network management control apparatus of an entry into the sleep mode when the bus or node in the first network is in the sleep ready state.

7. The vehicle system of claim 2, wherein the second vehicle network management control apparatus is configured to allow a sleep delay timer to start counting when receiving a sleep mode entry notification from the first vehicle network management control apparatus, and configured to transmit the sleep mode entry notification to the third vehicle network management control apparatus.

8. The vehicle system of claim 7, wherein the third vehicle network management control apparatus is configured to allow the sleep delay timer to start counting when receiving the sleep mode entry notification from the second vehicle network management control apparatus, and configured to allow a bus or node in the third network to enter the sleep mode when the counting of the sleep delay timer by the third vehicle network management control apparatus is completed.

9. The vehicle system of claim 7, wherein the second vehicle network management control apparatus is configured to allow a bus or node in the second network to enter the sleep mode when the counting of the sleep delay timer by the second vehicle network management control apparatus is completed.

10. The vehicle system of claim 8, wherein a counting value of the sleep delay timer of the second vehicle network management control apparatus is set to be smaller than a counting value of the sleep delay timer of the third vehicle network management control apparatus, and
wherein the sleep delay timers of the second and third vehicle network management control apparatuses are set to end simultaneously.

11. The vehicle system of claim 10, wherein the second and third vehicle network management control apparatuses notify the first vehicle network management control apparatus of completion of a sleep mode entry upon completion of the sleep mode entry.

12. The vehicle system of claim 1, wherein the entry into the sleep mode is stopped when at least one of the first to third vehicle network management control apparatuses receives a wake-up request or an error occurs in entering the sleep mode.

13. An apparatus for controlling vehicle network management, the apparatus comprising:
a processor configured to allow a sleep delay timer to start counting when a sleep mode entry is notified from an upper-level network management control apparatus managing a first network in a vehicle, and configured to allow a bus or node in a second network of the processor to enter a sleep mode when the counting of the sleep delay timer ends; and
storage configured to store a counting value of the sleep delay timer.

14. The vehicle system of claim 13, wherein the processor is configured to transmit a sleep mode entry notification to a lower-level vehicle network management control apparatus when the sleep delay timer starts counting.

15. The vehicle system of claim 14, wherein the processor notifies the upper-level network management control apparatus of completion of the sleep mode entry when the bus or node in the network enters the sleep mode.

16. The vehicle system of claim 14, wherein the processor is configured to allow the bus or node in the network to stop entering the sleep mode when the processor receives a wake-up request from an individual bus or an error occurs in entering the sleep mode.

17. A method of controlling management of a vehicle network which includes at least one vehicle network management control apparatus, the method comprising:
receiving a sleep mode entry notification from an upper-level vehicle network management control apparatus;
starting counting of a sleep delay timer; and
performing a sleep mode entry of a network when the counting of the sleep delay timer ends.

18. The method of claim 17, further comprising notifying the upper-level vehicle network management control apparatus of sleep mode entry completion when the sleep mode entry is completed.

19. The method of claim 17, further comprising stopping the sleep mode entry when a wake up request is received from a bus or node or an error occurs in entering the sleep mode.

20. The method of claim 17, further comprising notifying the sleep mode entry when the upper-level vehicle network management control apparatus does not receive a network management message from a bus or node for a preset period time.
